(19) United States
(12) Patent Application Publication
(10) Pub. No.: US 2012/0010860 A1
(43) Pub. Date: Jan. 12, 2012

(54) SYSTEM, METHOD, AND APPARATUS FOR ENGINE INSTALLATION INTEGRATION

(76) Inventors: Daniel R. Kirkling, Columbus, IN (US); Richard F. Miller, North Vernon, IN (US); Deepak Khedkar, Columbus, IN (US)

(21) Appl. No.: 13/112,139

(22) Filed: May 20, 2011

Related U.S. Application Data
(60) Provisional application No. 61/346,627, filed on May 20, 2010.

(51) Int. Cl. G06F 17/50

(52) U.S. Cl. 703/1

(57) ABSTRACT

A computer program product including a program that causes the computer to perform operations when the computer executes the program includes instructions to provide an engine specification interface to a user over a web-based application, and to receive an application specification including a three-dimensional description of application space available to accommodate an engine and a parameter for an engine application. The instructions include accessing an engine specification in response to the parameter for the engine application, where the engine specification includes a three-dimensional digital description of an engine and specified additional hardware. The instructions include evaluating compatibility between the engine specification and the application specification, and providing a CAD file to the user, where the CAD file includes the three-dimensional digital description of an engine and specified additional hardware.

### RELATED APPLICATIONS

This application is related to, and claims the benefit of, U.S. Provisional Patent Application 61/346,627 entitled “SYSTEM, METHOD, AND APPARATUS FOR ENGINE INSTALLATION INTEGRATION”, filed on May 20, 2010, which is incorporated herein by reference in the entirety for all purposes.

### BACKGROUND

The present application relates to integrating engine installation information, and more particularly but not exclusively relates to providing rapid and configurable engine integration information to a customer. A particular engine platform as utilized by a customer may include multiple options for power ratings, hardware, emissions components, and related devices that create literally thousands of potential footprint and interface concerns for installing the engine into a final application. Currently available processes for specifying an engine can take many hours spread across multiple business days, and require input from multiple people in different areas of expertise introducing the possibility of miscommunication and delay. Accordingly, there is a demand for further improvements relating to engine installation integration.

### SUMMARY

One embodiment is a unique method for determining customer engine requirements and delivering integration information to a customer. Further embodiments, forms, objects, features, advantages, aspects, and benefits shall become apparent from the following description and drawings.

### BRIEF DESCRIPTION OF THE FIGURES

FIG. 1 is a schematic diagram of a system for providing an engine specification to a customer.

FIG. 2 is a schematic block diagram of a processing subsystem for providing an engine specification to a customer.

FIG. 3 is an illustration of an application specification.

FIG. 4 is an illustration of an engine specification.

FIG. 5 is a schematic flow diagram of a procedure for providing an engine specification to a customer.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, and any alterations and further modifications in the illustrated embodiments, and any further applications of the principles of the invention as illustrated therein as would normally occur to one skilled in the art to which the invention relates are contemplated and protected.

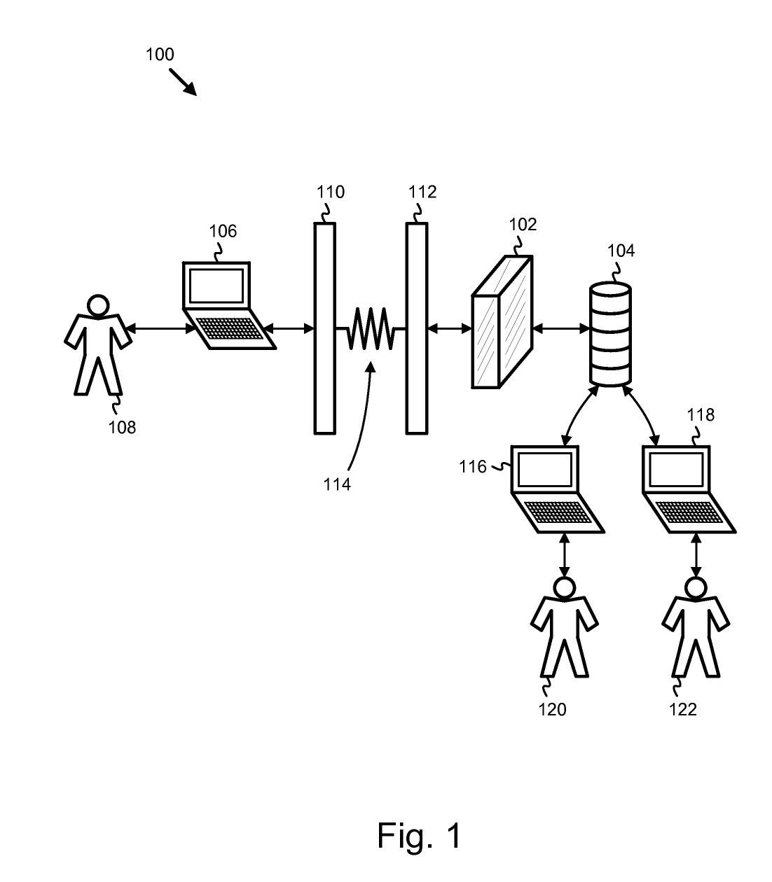

FIG. 1 is a schematic diagram of a system 100 for providing an engine specification to a customer. The system 100 includes a user-side network 110 in communication with an engine specification provider network 112, with the networks in communication over a wide-area network 114 such as the internet. The system 100 further includes a computer 102 and a storage system 104 on the engine specification provider network 112 side. In one embodiment, the system 100 includes computers 116, 118 in communication with the storage system 104, and operators 120, 122 or other input mechanisms (not shown) provide supporting information to the storage system 104 to further operations of the computer 102 in providing engine specifications to the user 108. The user 108 may be a customer communicating with the user-side network 110 through a computer 106.

The system 100 is illustrated as an exemplary schematic diagram of relationships. Particular embodiments of the system 100 may utilize various computers instead of or in addition to computers 102, 106, 116, 118 in other configurations, and data may be stored in various storage systems instead of or in addition to storage system 104 and/or generated in real-time during operations of the system 100.

One exemplary illustration of operations of system 100 includes the user 108 providing an application specification to the computer 102 by entering communications into a computer 106. The application specification includes information about an application (not shown) in which an engine (not shown) will be utilized, and can include any information that may be of interest to a user of an engine. For example, and without limitation, the application specification may include a power rating (e.g. kw or hp), a torque rating, a displacement, a desired electronic feature of the engine (e.g. cruise control or a torque management feature), an engine oil change interval, or other information specifying requirements or parameters for a given application of an engine. The user 108 may further select an engine specification from a menu of engine specifications provided by the computer 102, or the computer 102 may determine an engine specification according to defaults, estimates, or preliminary parsing of the application specification.

Various parameters of the application specification may be marked with an indicator such as, but not limited to, required, desired, maximize, or minimize. For example, a parameter horsepower rating may be entered as “450 hp” marked required, and “fuel economy” marked to maximize. In the example, the computer 102 provides one or more engine specifications having the horsepower rating requirement (if possible) and having a maximum available fuel economy rating from available engine specifications.

The computer 102 may access engine specification information pre-loaded onto the storage system 104, which may be provided by the computers 116, 118 and operators 120, 122. For example, computer 116 may provide technical information about engines (e.g. power ratings, torque ratings) and computer 118 may provide computer-aided design (CAD) drawings, and the first operator 120 may be an engineer and the second operator 122 may be a draftsperson. Of course, computers 116, 118 and operators 120, 122 are simply exemplary and multiple engineers, drafters, salespersons, manufacturing personnel, and additional or alternate operators and computers may be utilized to provide information to the storage system 104. Additionally, the storage system 104 and computer 102 may be distributed and/or networked devices, and information may be generated or updated during the operation of the system 100 rather than or in addition to being stored. In one example, the CAD drawing is generated at run-time according to the selected engine and selected features and options.

The engine specification includes any information relevant to particular engine designs that may be of interest to the user 108 or to matching the application specification. For example, and without limitation, the engine specification includes technical ratings of the engine (e.g., power, torque, oil capacity), electronic features available on the engine, cost information for the engine, the availability and/or inventory of the engine, warranty information about the engine, and a three-dimensional CAD drawing (or digitally stored equivalent) of the engine and certain specified hardware (e.g. turbocharger, aftertreatment components, grid heater elements) related to the engine. The three-dimensional CAD drawing of the engine and/or specified hardware related to the engine may be dependent upon certain aspects of the engine as specified, and may be determined at run-time. For example, the specific horsepower rating of an engine may indicate a change in a turbocharger or other hardware component of the engine, changing the physical footprint and CAD information of the engine and specified hardware.

The computer 102 may execute program operations or be otherwise configured to perform multiple functions. For example, in the exemplary system 100, the computer 102 compares the application specification to the engine specification to determine if the specifications are compatible. In various additional embodiments, the computer 102 may determine a list of engine specifications that are compatible, determine one or more engine specifications that are partially compatible with the application specification, determine an adjustment to the application specification and provide one or more engine specifications that are compatible with the adjusted application specification. The computer 102 then provides the user 108 with at least a part of the engine specification(s) that are compatible or partially compatible with the application specification or the adjusted application specification. The computer 102 includes a three-dimensional description of the engine and specified hardware, potentially including the CAD drawing file, all or a portion of which can be provided to the user 108. The computer 102 may include the three-dimensional description of the engine and specified hardware in response to a user 108 input, for example the user 108 selecting an engine specification from a list of compatible (or partially compatible) engine specifications.

In certain embodiments, the computer 102 accepts markings on one or more parameters of the application specification, including whether various parameters are desired, required, or should be minimized or maximized. For example, the application specification may include a parameter of a 325 kilowatt (kw) +/−10% power requirement and a second parameter to maximize the torque value. In the present example, the computer returns an engine specification, including the CAD drawing, for the engine specification on the storage system 104 within the power requirement having the highest available torque. For example, if two engines are available, the first having a rating of 325 kw and 1500 newton-meters (nm), and a second engine having a rating of 345 kw and 1600 nm, the computer 102 returns the engine specification information for the second engine having a rating of 345 kw and 1600 nm.

In another example, the user 108 may select engine specifications from a menu according to an application specification known by the user 108, and therefore the compatibility of the application specification and the engine specification may be provided on the user-side network 110 in certain embodiments. The operations of the exemplary system 100 allow a remote user 108 to quickly verify an engine specification for a given application, and to immediately receive a CAD drawing and other interface information about the selected engine with the features and options selected by the user 108.

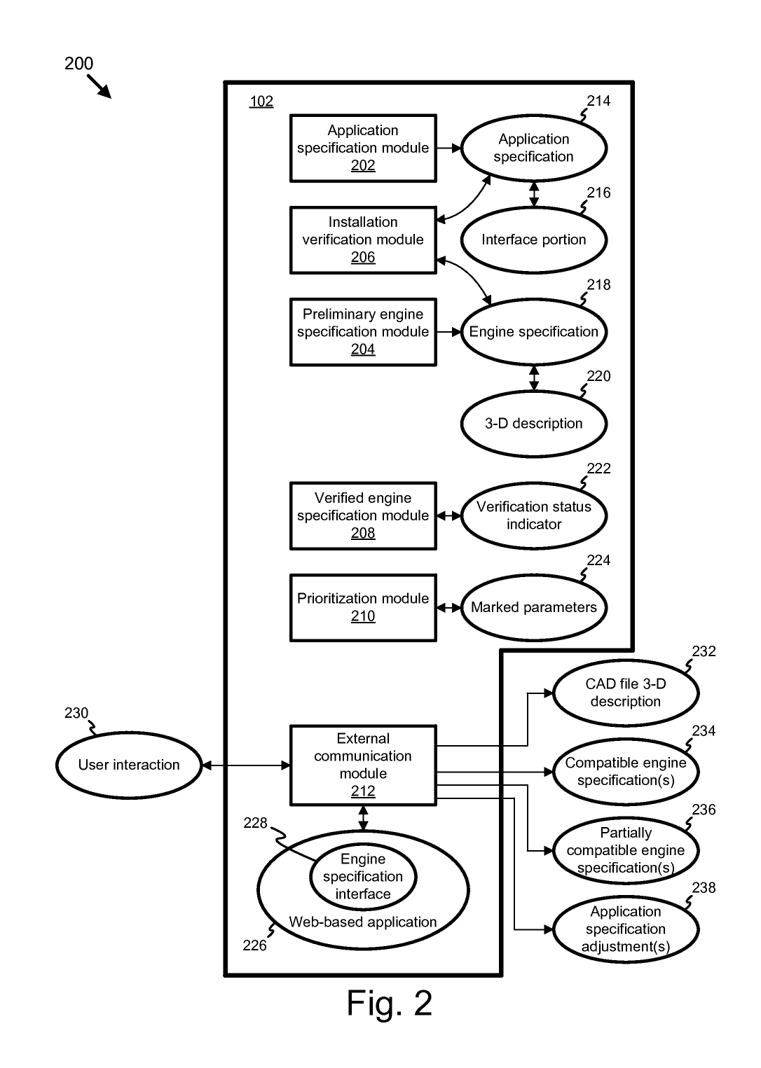

FIG. 2 is a schematic block diagram of a processing subsystem 200 for providing an engine specification to a customer. The processing subsystem 200 includes a controller, that may be a part of a computer 102 or that may be a distributed device. The controller includes modules configured to provide multiple functionalities relating to providing the engine specification to the end user as well as providing other functionalities. The computer 102, in certain embodiments, communicates with the user 108 utilizing a web-based application that provides menus, selections, defaults, and/or other interface elements to allow the user 108 to provide an application specification to the computer 102.

The exemplary embodiments described herein may include a number of modules providing a number of functionalities. A module may be implemented as operations by software, hardware or a combination thereof, or at least partially performed by a user or operator. In certain embodiments, modules represent software elements as a computer program encoded on a computer readable medium, wherein a computer performs the described operations when executing the computer program. A module may be a single device, distributed across devices, and/or a module may be grouped in whole or part with other modules or devices. The operations of any module may be performed wholly or partially in hardware, software, or by other modules. The presented organization of the modules is exemplary only, and other organizations, configurations and arrangements are contemplated.

Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art, and/or by receiving a value by which the interpreted parameter can be calculated, and/or by referencing a default value that is interpreted to be the parameter value.

The computer 102 in FIG. 2 includes an application specification module 202, a preliminary engine specification module 204, an installation verification module 206, a verified engine specification module 208, a prioritization module 210, and an external communication module 212.

The application specification module 202 interprets an application specification 214 including one or more parameters for an engine application. Exemplary and non-limiting parameter(s) for the engine application include: an application torque rating, an application torque rating corresponding to a selected gear ratio, an application horsepower rating, an application electrical system rating, an application emissions rating, an application engine weight value, an application engine geometric dimension, an application fuel type, an application oil change interval requirement, an application aftertreatment system description, an application electrical interface requirement, an application datalink communication requirement, an application maintenance interval requirement, an application electronic feature description, an application warranty description, an application cost value, an application availability indicator, an application transmission compatibility indicator, an application geographic compatibility indicator, and/or an application maximum engine speed rating.

The application specification 214, in certain embodiments, further includes a three-dimensional description of an interface portion 216, or a three-dimensional description of application space available to accommodate an engine. The application specification 214 includes information supplied by the user 108, or supplied by the application specification module 202 according to estimates or defaults, describing required or desired features of an engine to be utilized in an application.

The preliminary engine specification module 204 interprets an engine specification 218 including at least one engine parameter and a three-dimensional digital description 220 of an engine and specified additional hardware. The preliminary engine specification module 204 determines the engine specification 218 according to selections by the user 108, according to preliminary parsing of the application specification 214, and/or according to estimates or defaults. For example, the application specification 214 may include a power rating and other information, and the preliminary engine specification module 204 determines the engine specification 218 is according to the power rating from available engine specifications on the storage device 104. In certain embodiments, the preliminary engine specification module 204 interprets the engine specification 218 according to user interactions 230, and the engine specification 218 may include specifications for multiple engines.

The installation verification module 206 evaluates a compatibility between the at least one engine parameter of the engine specification 218 and the parameter(s) for the engine application from the application specification 214. In one example, the application specification 214 includes application parameters for a power rating, a torque rating, and a geometric dimension of the engine (e.g. a maximum height, length, width and/or other dimension(s)), and the installation verification module 206 determines from the engine specification 218 whether the engine parameters meet the criteria of the application parameters. The application specification 214 can include multiple specifiable parameters for an engine, including without limitation, the type and compositions of ancillary parts, coolant ratings, speed ratings, electronic or other features, warranty data, types of fuel, lubricant, or maintenance parts, maintenance intervals, color of the engine or components, emissions ratings or performance, aftertreatment components, supported engine duty cycle, and engine durability information.

In certain embodiments, the installation verification module 206 further evaluates the compatibility between the application specification 214 and the engine specification 218 by comparing the three-dimensional description of application space available to accommodate the engine and the three-dimensional digital description of the engine and specified additional hardware. In one example, where a collision detection algorithm determines the engine and specified hardware can be positioned within the application space available, the engine specification 218 and application specification 214 are evaluated to be compatible.

In certain embodiments, the prioritization module 210 determines values for marked parameters 224 from the application specification 214, and the installation verification module 206 further verifies the compatibility of the engine specification 218 with the application specification 214 in response to the marked parameter(s) 224. The marked parameter(s) 224 include prioritization descriptions such as required, desired, maximize, and/or minimize. Any number of parameters from the application specification 214 may be marked, including none of the parameters or all of the parameters.

The verified engine specification module 208 provides the three-dimensional digital description 220 of the engine and the specified additional hardware to an output device. The output device may be a computer screen, a printer, or a digital medium such as a network communication link or a storage device. In one example, the verified engine specification module 208 provides the three-dimensional digital description 220 of the engine and the specified additional hardware to an external communication module 212, which provides a computer-aided design (CAD) file 232 to the user 108.

In certain embodiments, the external communication module 212 provides an engine specification interface 228 to a user over a web-based application 226 and receives a user interaction 230 through the engine specification interface 228. The preliminary engine specification module 204 generates the engine specification 218 in response to the user interaction 230, and the verified engine specification module 208 further provides a computer-aided design (CAD) file to the user. The CAD file includes the three-dimensional digital description 220 of the engine and the specified additional hardware. In certain embodiments, the installation verification module 206 determines a verification status indicator 222 indicating whether the at least one engine parameter is compatible with the at least one application parameter, and the verified engine specification module 208 provides the verification status indicator 222 to the user.

In one example, the verification status indicator 222 indicates that at least one engine parameter of the engine specification 218 is not compatible with at least one application parameter of the application specification 214. In response, the verified engine specification module 208 provides at least one compatible engine specification 234 (i.e., that is compatible with the application specification 214), a list of compatible engine specifications 234, a partially compatible engine specification 236, and/or an application specification adjustment 238 wherein an engine specification 218 is available that is compatible with the application specification adjustment 238.

For example, the application specification 214 may have a power rating of 350 kw, a torque rating of 1750 nm, and a rated engine speed of 2800 rpm. The preliminary engine specification module 204 may reference the closest available engine specifications 218, and the installation verification module 206 provides a compatible engine specification 234 and/or a list of compatible engine specifications 234. In response to the installation verification module 206 determining that no available engine specification 218 is compatible, the verified engine specification module 208 may provide a list of one or more partially compatible engine specifications 236 (e.g., an engine specification 218 having 350 kw, a torque rating of 1650 nm, and a rated engine speed of 2500 rpm is partially compatible, and/or an application specific adjustment 238. For example, where a first engine specification is available meeting the power and torque ratings, and a second engine specification is available meeting the power and rated speed ratings, the verified engine specification module 208 determines a first application specific adjustment 238 to meet the rated speed of the first engine specification and a second application specific adjustment 238 to meet the rated torque of the second engine specification.

In certain embodiments, the external communication module 212 provides the CAD file three dimensional descriptions 232 of any engine specification provided to the user 108, or may provide CAD file three dimensional descriptions 232 of any user-selected engine specifications from the specifications 234, 236 provided to the user 108. In certain embodiments, the external communication module 212 provides prompts and information to the user 108 such that the user can select an engine specification 234, 236, and/or select an application specification adjustment 238 to adopt from the provided application specification adjustments 238.

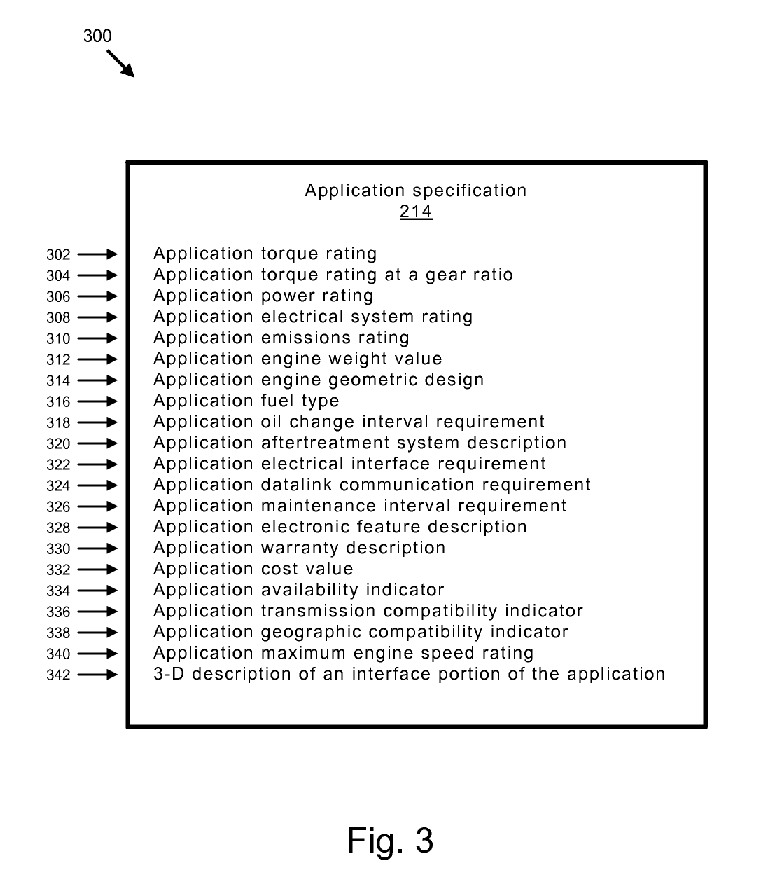

FIG. 3 is an illustration of an application specification 214. The application specification 214 is at least partially provided by a user 108 or external computer 106, for example an automated system that orders engines for a customer. The application specification 214 in the example shown includes application parameter(s) of an application torque rating 302, an application torque rating corresponding to a selected gear ratio 304, an application power rating 306, an application electrical system rating 308, an application emissions rating 310, an application engine weight value 312, an application engine geometric dimension 314, an application fuel type 316, an application oil change interval requirement 318, an application aftertreatment system description 320, an application electrical interface requirement 322, an application datalink communication requirement 324, an application maintenance interval requirement 326, an application electronic feature description 328, an application warranty description 330, an application cost value 332, an application availability indicator 334, an application transmission compatibility indicator 336, an application geographic compatibility indicator 338, an application maximum engine speed rating 340, and/or a three dimensional description of an interface portion of an application 342.

The external communication module 212 receives the application specification 214 over a network 110. The application specification 214 may include some, all, or none of the presented application parameters, and may include some parameters not illustrated in FIG. 3. Further, the external communication module 212 may populate the application specification 214 with default values in some instances, and may allow some values to remain blank. The external communication module 212 may allow any type of input from the web-based application 226, including selections from a list, free entry of data, downloading of formatted files, and other types of input methods.

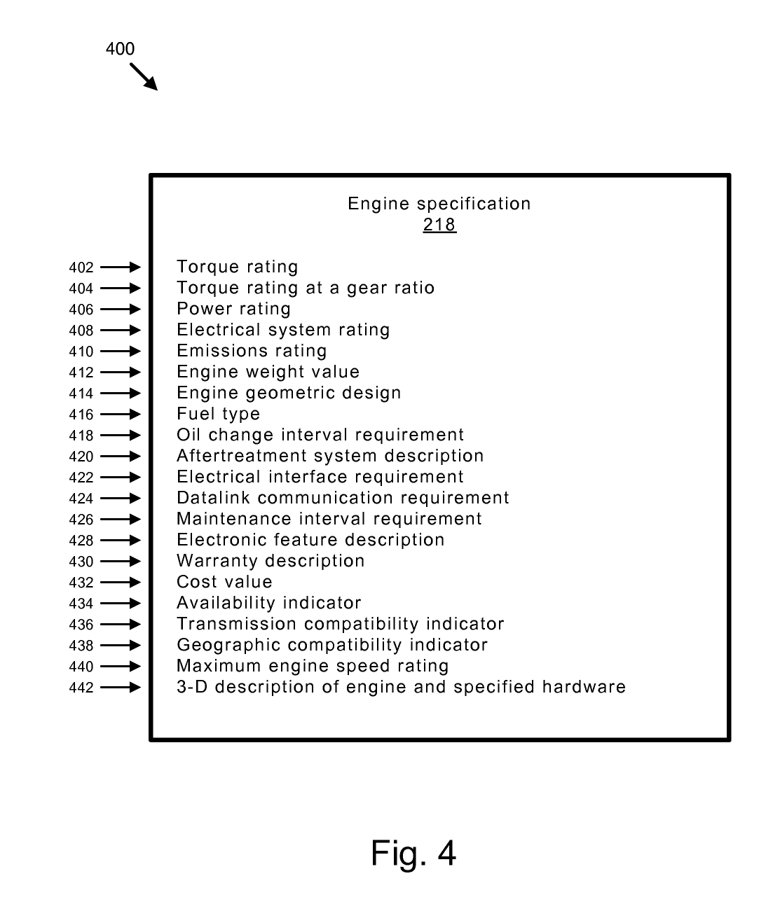

FIG. 4 is an illustration of an engine specification 218. The engine parameter(s) include a torque rating 402, a torque rating corresponding to a selected gear ratio 404, a power rating 406, an electrical system rating 408, an emissions rating 410, a weight value 412, a geometric dimension 414, a fuel type 416, an oil change interval requirement 418, an aftertreatment system description 420, an electrical interface requirement 422, a datalink communication requirement 424, a maintenance interval requirement 426, an electronic feature description 428, a warranty description 430, a cost value 432, an availability indicator 434, a transmission compatibility indicator 436, a geographic compatibility indicator 438, a maximum engine speed rating 440, and/or a three dimensional description of the engine and specified hardware 442.

The preliminary engine specification module 204 retrieves engine specifications 218 from a data store 104 according to the application specification 214. The rules for determining which engine specifications 218 to retrieve are specified in advance, or assigned by the user 108 or an operator 120, 122. For example, the preliminary engine specification module 204 may pull any engine specification 218 that meets the application specification 214 criteria or that meets certain criteria such as torque rating 402 or power rating 406 or engine displacement (not shown). The preliminary engine specification module 204 may pull any engine specification 218 that is closest to the application specification 214 in one or more important criteria. The rules for determining which engine specifications 218 to retrieve may be further determined according to how many engine specifications 218 appear to be available, for example relaxing the criteria where few engine specifications 218 appear to be available, and tightening the criteria where many engine specifications 218 appear to be available. Further, the rules for determining which engine specifications 218 to retrieve may be further determined according to the marked parameters 224 provided by the prioritization module 210.

The verified engine specification module 208 then determines the verification status indicator 222 according to the application specification 214 and the engine specification(s) 218, determining whether one or more compatible or partially compatible engine specification(s) 234, 236 are available. The determination of which engine specifications 218 are compatible or partially compatible may be further determined according to the marked parameters 224 provided by the prioritization module 210. For example, a marked parameter 224 may be determined to be more important or weighted more heavily than other parameters, may be listed as desired but optional, and/or may be listed as a parameter to be maximized, minimized, or held as closely as possible to a certain value, but not to be determined as incompatible based on a specific value.

For example, two marked parameters 224 may be an application torque rating 302 and an application power rating 306, where the application torque rating 302 is to be maximized and the application power rating 306 is to be between 300 and 350 kw. In a further example, if three engine specifications 218 are available, having torque ratings 402 of 1500, 1400, and 1600 nm respectively, and power ratings 406 of 300, 340, and 360 kw respectively, the verified engine specification module 208 provides a compatible engine specification 234 of the engine specification 218 having a torque rating 402 of 1500 nm and a power rating of 300 kw. In another example, certain parameters of the application specification 214 may be marked parameters 224 for purposes of determining partial compatibility. In the example, an application emissions rating 310 may be marked as a requirement such that an engine specification 218 that does not meet the application emissions rating 310 is not available as a partially compatible engine specification 236, but the application torque rating 302 may be marked such that an engine specification 218 that does not meet the application torque rating 302 is available as a partially compatible engine specification 236.

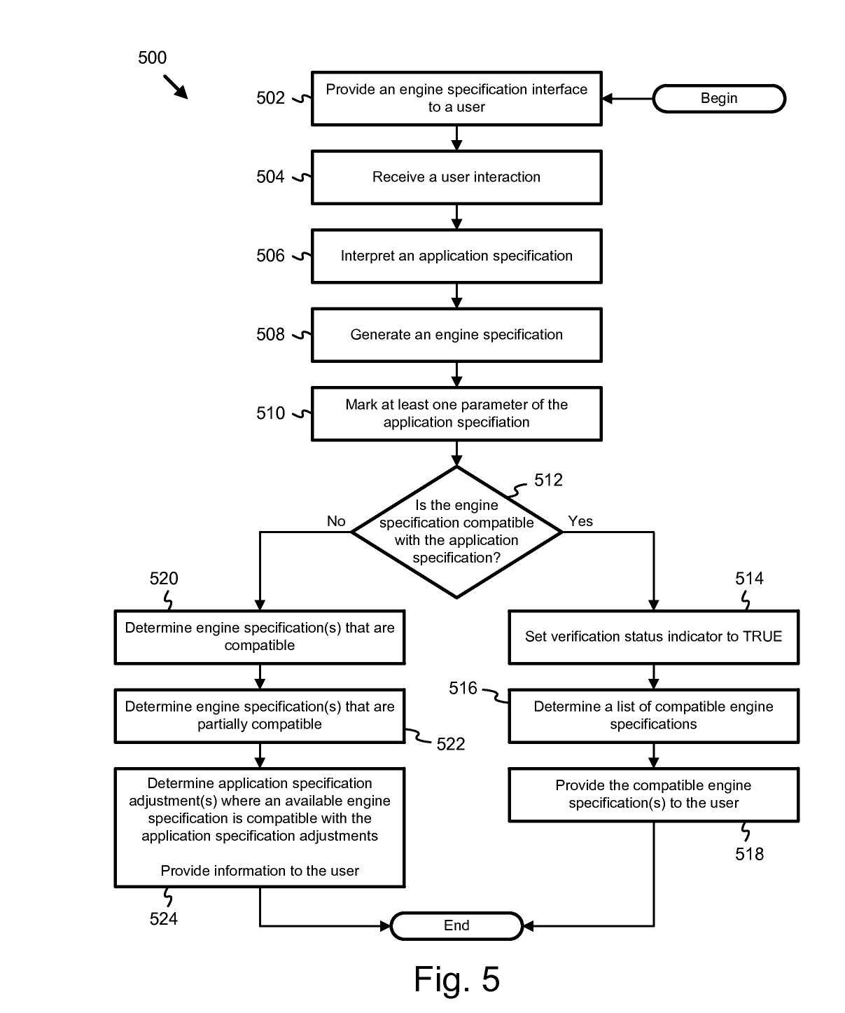

The schematic flow diagram in FIG. 5, and the related descriptions which follow, are illustrative embodiments of a technique for engine installation integration. Operations illustrated are understood to be exemplary only, and operations may be combined or divided, and added or removed, as well as re-ordered in whole or part, unless explicitly stated to the contrary. The technique 500 may be implemented by one or more computer(s) executing one or more computer program(s) stored on a computer accessible medium. The computer program(s) comprises instructions causing the computer to execute one or more of the operations of the technique 500. In certain embodiments the computer program(s) may be comprised of modules, such as those described herein.

The technique 500 includes an operation 502 to provide an engine specification interface to a user and an operation 504 to receive a user interaction. The technique 500 further includes an operation 506 to interpret an application specification, which may be at least partially provided by the user interaction, and an operation 508 to generate an engine specification in response to the application specification. The technique 500 further includes an operation 510 to mark at least one parameter of the application specification. The technique 500 further includes an operation 512 to determine if the engine specification(s) are compatible with the application specification. The operation 512 to determine if the engine specification(s) are compatible may be dependent upon the marked parameter(s) of the application specification. The technique 500 further includes, in response to the operation 512 determining there is not a compatible engine specification, an operation 520 to determine whether an engine specification is available that is compatible that has not been checked. For example, the operation 520 can be an operation to notify the preliminary engine specification module 204 to relax screening criteria and check additional specifications, an operation to query an operator 120, 122 whether an engine specification is available that is not yet stored on the data store 104, or any other operation to check engine specifications that were not checked in the operation 512. The technique 500 further includes an operation 522 to determine whether an engine specification is available that is partially compatible with the application specification 214 and an operation 524 to determine an application specification adjustment 238 and provide the compatible engine specifications, partially compatible engine specifications, and application specification adjustments to the user.

The technique 500 further includes, in response to the operation 512 determining there is a compatible engine specification, an operation 514 to set a verification status indicator to TRUE, an operation 516 to determine a list of compatible engine specifications, and an operation 518 to provide the compatible engine specifications and the verification status indicator to the user.

As is evident from the figures and text presented above, a variety of embodiments according to the present invention is contemplated.

An exemplary set of embodiments is a method including accessing an application specification including a three-dimensional description of application space available to accommodate an engine and a parameter for an engine application; accessing an engine specification in response to the parameter for the engine application; evaluating compatibility between the engine specification and the application specification, where the evaluating the compatibility includes evaluating that the engine specification spatially interfaces with the application specification; and providing a digital description of the engine to an output device based upon the evaluating compatibility, the digital description including information from the engine specification of the type specified by the parameter for the engine application.

An exemplary method further includes the parameter for the engine application including one or more of the parameters selected from an application torque rating, an application torque rating corresponding to a selected gear ratio, an application horsepower rating, an application electrical system rating, an application emissions rating, an application engine weight value, an application engine geometric dimension, an application fuel type, an application oil change interval requirement, an application aftertreatment system description, an application electrical interface requirement, an application datalink communication requirement, an application maintenance interval requirement, an application electronic feature description, an application warranty description, an application cost value, an application availability indicator, an application transmission compatibility indicator, an application geographic compatibility indicator, and/or an application maximum engine speed rating.

In certain further embodiments, the method includes accessing the engine specification by selecting an engine specification having an engine parameter consistent with the parameter for the engine application. An exemplary method includes evaluating compatibility by evaluating that the engine specification includes an engine parameter consistent with the parameter for the engine application. A further exemplary method includes determining a verification status indicator in response to the evaluating that the engine specification includes an engine parameter consistent with the parameter for the engine application, and providing the verification status indicator to the output device. A still further exemplary method includes in response to the verification status indicator indicating that the engine specification does not include an engine parameter consistent with the parameter for the engine application, providing to the output device at least one of: at least one alternate engine specification that includes an engine parameter consistent with the parameter for the engine application; a list of alternate engine specifications that each include an engine parameter consistent with the parameter for the engine application; at least one engine specification that is at least partially compatible with the application specification; and an application specification adjustment wherein an engine specification is available that is compatible with the application specification adjustment.

In certain embodiments, the method includes determining a list of compatible engine specifications in response to the application specification, and providing the list of compatible engine specifications to the user. An exemplary method includes the engine specification having a three-dimensional digital description of an engine and additional hardware, where the evaluating compatibility includes comparing the three-dimensional digital description of the engine and additional hardware to the three-dimensional description of the application space available. A further exemplary method includes providing an engine specification interface to a user over a web-based application, generating the engine specification in response to user interaction through the engine specification interface, and providing the three-dimensional digital description of the engine and additional hardware to the output device as a computer-aided design (CAD) file.

Another exemplary method includes marking at least one parameter for the engine application with a value selected from the values consisting of: required, desired, maximize, and minimize. In certain embodiments, the method further includes evaluating compatibility further in response to the marked application parameter(s).

Another exemplary embodiment is an apparatus including a processing subsystem having a controller. The controller includes modules structured to functionally execute operations for providing a verified engine specification. The exemplary controller includes an application specification module, a preliminary engine specification module, an installation verification module, a verified engine specification module, a prioritization module, and/or an external communication module. The application specification module interprets an application specification including a three-dimensional description of application space available to accommodate an engine and a parameter for an engine application. The preliminary engine specification module interprets an engine specification including at least one engine parameter and a three-dimensional digital description of an engine and specified additional hardware. The installation verification module verifies a compatibility between the application specification and the engine specification, and the verified engine specification module provides the three-dimensional digital description of the engine and the specified additional hardware to an output device.

Exemplary engine parameter(s) include, without limitation, a torque rating, a torque rating corresponding to a selected gear ratio, a horsepower rating, an electrical system rating, an emissions rating, a weight value, a geometric dimension, a fuel type, an oil change interval requirement, an aftertreatment system description, an electrical interface requirement, a datalink communication requirement, a maintenance interval requirement, an electronic feature description, a warranty description, a cost value, an availability indicator, a transmission compatibility indicator, a geographic compatibility indicator, and/or a maximum engine speed rating. The parameter(s) for the engine application include an application torque rating, an application torque rating corresponding to a selected gear ratio, an application horsepower rating, an application electrical system rating, an application emissions rating, an application engine weight value, an application engine geometric dimension, an application fuel type, an application oil change interval requirement, an application aftertreatment system description, an application electrical interface requirement, an application datalink communication requirement, an application maintenance interval requirement, an application electronic feature description, an application warranty description, an application cost value, an application availability indicator, an application transmission compatibility indicator, an application geographic compatibility indicator, and/or an application maximum engine speed rating.

In certain embodiments, the apparatus includes a prioritization module that marks at least one parameter for the engine application with a value selected from required, desired, maximize, and/or minimize. The installation verification module verifies the compatibility further in response to the marked parameter(s). An exemplary apparatus further includes an external communication module that provides an engine specification interface to a user over a web-based application, and receives a user interaction through the engine specification interface. The preliminary engine specification module interprets the engine specification in response to the user interaction, and the verified engine specification module further provides a computer-aided design (CAD) file to the user. The CAD file includes the three-dimensional digital description of the engine and the specified additional hardware.

In certain further embodiments, the installation verification module determines a verification status indicator indicating whether the engine specification is compatible with the parameter for the engine application. The verified engine specification module further provides the verification status to the user. A further embodiment includes, in response to the verification status indicator indicating that the engine parameter is not compatible with the parameter for the engine application, the verified engine specification module providing: at least one engine specification that is compatible with the application specification; a list of engine specifications that are compatible with the application specification; at least one engine specification that is at least partially compatible with the application specification; and/or an application specification adjustment wherein an engine specification is available that is compatible with the application specification adjustment.

Yet another exemplary set of embodiments is a computer program product including a computer useable medium having a computer readable program, wherein the computer readable program when executed on a computer causes the computer to provide an engine specification interface to a user over a web-based application and receive a user interaction through the engine specification interface, where the user interaction communicates an application specification comprising a three-dimensional description of application space available to accommodate an engine and a parameter for an engine application. The instructions further cause the computer to access an engine specification in response to the parameter for the engine application, where the engine specification includes a three-dimensional digital description of an engine and specified additional hardware, and to evaluate compatibility between the engine specification and the application specification. The evaluating compatibility includes comparing the three-dimensional digital description of the engine and additional hardware to the three-dimensional description of the application space available. The instructions further cause the computer to provide a computer-aided design (CAD) file to the user, wherein the CAD file comprises the three-dimensional digital description of the engine and the specified additional hardware.

In certain further embodiments, the computer readable program when executed on the computer further causes the computer to evaluate compatibility by evaluating whether the engine specification includes an engine parameter consistent with the parameter for the engine application. Additionally or alternatively, the computer readable program when executed on the computer further causes the computer to mark the parameter for the engine application with a value selected from the values consisting of required, desired, maximize, and minimize, and to evaluate compatibility further in response to the marked parameter for the engine application.

An exemplary computer readable program when executed on the computer further causes the computer to determine a list of compatible engine specifications in response to the evaluating, and provide the list of compatible engine specifications to the user. Another exemplary computer readable program when executed on the computer further causes the computer to determine a verification status indicator in response to the evaluating, and to provide the verification status indicator to the user. In certain embodiments, the exemplary computer readable program when executed on the computer further causes the computer to provide at least one of: at least one engine specification that is compatible with the application specification, a list of engine specifications that are compatible with the application specification, at least one engine specification that is at least partially compatible with the application specification, and/or an application specification adjustment wherein an engine specification is available that is compatible with the application specification adjustment.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
accessing an application specification including a three-dimensional description of application space available to accommodate an engine and a parameter for an engine application;
accessing an engine specification in response to the parameter for the engine application;
evaluating compatibility between the engine specification and the application specification, wherein the evaluating compatibility comprises evaluating that the engine specification spatially interfaces with the application specification; and
providing a digital description of the engine to an output device based upon the evaluating compatibility, the digital description including information from the engine specification of a type specified by the parameter for the engine application.

2. The method of claim 1, wherein the parameter for the engine application comprises at least one parameter selected from the parameters consisting of: an application torque rating, an application torque rating corresponding to a selected gear ratio, an application horsepower rating, an application electrical system rating, an application emissions rating, an application engine weight value, an application engine geometric dimension, an application fuel type, an application oil change interval requirement, an application aftertreatment system description, an application electrical interface requirement, an application datalink communication requirement, an application maintenance interval requirement, an application electronic feature description, an application warranty description, an application cost value, an application availability indicator, an application transmission compatibility indicator, an application geographic compatibility indicator, and an application maximum engine speed rating.

3. The method of claim 2, wherein the accessing the engine specification comprises selecting an engine specification having an engine parameter consistent with the parameter for the engine application.

4. The method of claim 2, wherein the evaluating compatibility further comprises evaluating that the engine specification includes an engine parameter consistent with the parameter for the engine application.

5. The method of claim 4, further comprising determining a verification status indicator in response to the evaluating that the engine specification includes an engine parameter consistent with the parameter for the engine application, and providing the verification status indicator to the output device.

6. The method of claim 5, further comprising, in response to the verification status indicator indicating that the engine specification does not include an engine parameter consistent with the parameter for the engine application, providing to the output device at least one of:
at least one alternate engine specification that includes an engine parameter consistent with the parameter for the engine application;
a list of alternate engine specifications that each include an engine parameter consistent with the parameter for the engine application;
at least one engine specification that is at least partially compatible with the application specification; and
an application specification adjustment wherein an engine specification is available that is compatible with the application specification adjustment.

7. The method of claim 1, further comprising determining a list of compatible engine specifications in response to the application specification, and providing the list of compatible engine specifications to the user.

8. The method of claim 1, wherein the engine specification includes a three-dimensional digital description of an engine and additional hardware, and wherein the evaluating compatibility includes comparing the three-dimensional digital description of the engine and additional hardware to the three-dimensional description of the application space available.

9. The method of claim 8, further comprising providing an engine specification interface to a user over a web-based application, generating the engine specification in response to user interaction through the engine specification interface, and providing the three-dimensional digital description of the engine and additional hardware to the output device as a computer-aided design (CAD) file.

10. The method of claim 2, further comprising marking at least one parameter for the engine application with a value selected from the values consisting of required, desired, maximize, and minimize.

11. The method of claim 10, wherein the evaluating compatibility is further in response to the at least one marked application parameter.

12. An apparatus, comprising:
an application specification module structured to interpret an application specification comprising a three-dimensional description of application space available to accommodate an engine and a parameter for an engine application;
a preliminary engine specification module structured to interpret an engine specification comprising at least one engine parameter and a three-dimensional digital description of an engine and specified additional hardware;
an installation verification module structured to verify a compatibility between the application specification and the engine specification; and
a verified engine specification module structured to provide the three-dimensional digital description of the engine and the specified additional hardware to an output device.

13. An apparatus according to claim 12, wherein the at least one engine parameter comprises at least one parameter selected from the parameters consisting of a torque rating, a torque rating corresponding to a selected gear ratio, a horsepower rating, an electrical system rating, an emissions rating, a weight value, a geometric dimension, a fuel type, an oil change interval requirement, an aftertreatment system description, an electrical interface requirement, a datalink communication requirement, a maintenance interval requirement, an electronic feature description, a warranty description, a cost value, an availability indicator, a transmission compatibility indicator, a geographic compatibility indicator, and a maximum engine speed rating.

14. An apparatus according to claim 13, wherein the parameter for the engine application comprises at least one parameter selected from the parameters consisting of an application torque rating, an application torque rating corresponding to a selected gear ratio, an application horsepower rating, an application electrical system rating, an application emissions rating, an application engine weight value, an application engine geometric dimension, an application fuel type, an application oil change interval requirement, an application aftertreatment system description, an application electrical interface requirement, an application datalink communication requirement, an application maintenance interval requirement, an application electronic feature description, an application warranty description, an application cost value, an application availability indicator, an application transmission compatibility indicator, an application geographic compatibility indicator, and an application maximum engine speed rating.

15. An apparatus according to claim 14, further comprising:
a prioritization module structured to mark the parameter for the engine application with a value selected from the values consisting of required, desired, maximize, and minimize; and
wherein the installation verification module is further structured to verify the compatibility in response to the at least one marked parameter for the engine application.

16. An apparatus according to claim 12, further comprising an external communication module structured to provide an engine specification interface to a user over a web-based application and to receive a user interaction through the engine specification interface, wherein the preliminary engine specification module is further structured to interpret the engine specification in response to the user interaction, and wherein the verified engine specification module is further structured to provide a computer-aided design (CAD) file to the user, wherein the CAD file comprises the three-dimensional digital description of the engine and the specified additional hardware.

17. The apparatus of claim 16, wherein the installation verification module is further structured to determine a verification status indicator indicating whether the engine specification is compatible with the parameter for the engine application, and wherein the verified engine specification module is further structured to provide the verification status indicator to the user.

18. The apparatus of claim 17, wherein the verified engine specification module, in response to the verification status indicator indicating that the engine parameter is not compatible with the parameter for the engine application, is further structured to provide at least one of:
at least one engine specification that is compatible with the parameter for the engine application;
a list of engine specifications that are compatible with the parameter for the engine application;
at least one engine specification that is at least partially compatible with the application specification; and
an application specification adjustment wherein an engine specification is available that is compatible with the application specification adjustment.

19. A computer program product comprising a computer useable medium having a computer readable program, wherein the computer readable program when executed on a computer causes the computer to:
provide an engine specification interface to a user over a web-based application;
receive a user interaction through the engine specification interface, wherein the user interaction communicates an application specification comprising a three-dimensional description of application space available to accommodate an engine and a parameter for an engine application;
access an engine specification in response to the parameter for the engine application, the engine specification comprising a three-dimensional digital description of an engine and specified additional hardware;
evaluate compatibility between the engine specification and the application specification, wherein the evaluating compatibility comprises comparing the three-dimensional digital description of the engine and additional hardware to the three-dimensional description of the application space available; and
provide a computer-aided design (CAD) file to the user, wherein the CAD file comprises the three-dimensional digital description of the engine and the specified additional hardware.

20. The computer program product of claim 19, wherein the computer readable program when executed on the computer further causes the computer to evaluate compatibility by evaluating whether the engine specification includes an engine parameter consistent with the parameter for the engine application.

21. The computer program product of claim 20, wherein the computer readable program when executed on the computer further causes the computer to mark the parameter for the engine application with a value selected from the values consisting of required, desired, maximize, and minimize, and evaluate compatibility further in response to the marked parameter for the engine application.

22. The computer program product of claim 19, wherein the computer readable program when executed on the computer further causes the computer to determine a list of compatible engine specifications in response to the evaluating, and provide the list of compatible engine specifications to the user.

23. The computer program product of claim 19, wherein the computer readable program when executed on the computer further causes the computer to determine a verification status indicator in response to the evaluating, and to provide the verification status indicator to the user.

24. The computer program product of claim 19, wherein the computer readable program when executed on the computer further causes the computer to provide at least one of:
at least one engine specification that is compatible with the application specification;
a list of engine specifications that are compatible with the application specification;
at least one engine specification that is at least partially compatible with the application specification; and
an application specification adjustment wherein an engine specification is available that is compatible with the application specification adjustment.
